(19) United States
(12) Patent Application Publication
(10) Pub. No.: US 2017/0331188 A1
(43) Pub. Date: Nov. 16, 2017

(54) ADJUSTABLE MULTI-BAND ANTENNA AND ANTENNA DEBUGGING METHOD

(71) Applicant: ZTE CORPORATION, Shenzhen, Guangdong (CN)

(72) Inventor: Fei YIN, Shenzhen, Guangdong (CN)

(21) Appl. No.: 15/532,416

(22) PCT Filed: Sep. 7, 2015
(86) PCT No.: PCT/CN2015/089069

§ 371 Date: Jun. 1, 2017

(30) Foreign Application Priority Data
Dec. 2, 2014 (CN) 201410723218.X

(51) Int. Cl. H01Q 5/335; H01Q 5/50; H01Q 1/24

(52) U.S. Cl. CPC H01Q 5/335; H01Q 5/50; H01Q 1/24

(57) ABSTRACT

Disclosed are an adjustable multi-band antenna and an antenna debugging method. In the adjustable multi-band antenna of some embodiments includes: a first antenna unit connected with a first antenna impedance unit; the first antenna impedance unit connected with a first control unit; and the first control unit connected to a radio frequency circuit; a second antenna unit connected with a second control unit; the second control unit connected with the first control unit through a antenna matching unit, and grounded through a second antenna impedance unit; the first control unit configured to control conduction of the first antenna unit and the radio frequency circuit and conduction of the second antenna unit and the radio frequency circuit; and the second control unit configured to control connection of the second antenna unit with the antenna matching unit and the second antenna impedance unit.

### TECHNICAL FIELD

The present invention relates to the technical field of communications, and particularly relates to an adjustable multi-band antenna and an antenna debugging method.

### BACKGROUND

A helical antenna is generally adopted as an exterior antenna early. A bandwidth is adjusted primarily by adjusting density of spring coils and sizes of the coils. Such antenna form has better performance, but affects an appearance of a mobile phone. With development of modern communication technologies and continuous improvement of living level of people, mobile communication terminal products and especially the mobile phone are more and more popular. At present, the mobile phone is a portable article for us. Moreover, more and more functional requirements are proposed for the mobile phone. GPS, Bluetooth and WIFI are already integrated into the mobile phone currently. The number of antennas in the mobile phone is also increased. The antennas are more and more important for MIMO technical application in a 4G era especially. A volume of each antenna is always a critical factor for determining the bandwidth of the antenna. The smaller the size of the antenna is and the lower the height of the antenna is, the narrower the bandwidth is and the lower the antenna efficiency is. How to extend the bandwidth of an antenna in a limited space is a difficulty for antenna design at present and is also a main job without increasing the volume of the antennae. The performance of the antenna which acts as a device of the mobile phone is affected by a loud speaker, a camera, an LCD, a metal housing and other factors on the periphery. For a layout of a PCB, a layout of each mobile phone is different. Therefore, the antennas of each mobile phone must be customized.

At present, domestic and abroad mobile terminal antennas typically adopt built-in antennas as an Monopole antenna, an IFA antenna and a PIFA antenna. A lower part of an Monopole antenna body needs to be emptied, and has advantages of small volume and low height. The antennas are within a single frequency band, and the bandwidths of the antennas cannot be expanded without changing the volume of the antenna.

Therefore, an effective solution for expanding the bandwidth of the antenna without increasing the volume of the antenna is not given in an existing art.

### SUMMARY

Embodiments of the present invention provide an adjustable multi-band antenna and an antenna debugging method, so as to at least solve a technical problem about how to extend the bandwidth of the antenna without increasing a volume of the antenna in a related art.

To solve the above technical problem, embodiments of the present invention provide an adjustable multi-band antenna, including: a first antenna unit, a second antenna unit, a first antenna impedance unit, a second antenna impedance unit, a first control unit, an antenna matching unit and a second control unit.

The first antenna unit is connected with the first antenna impedance unit; the first antenna impedance unit is connected with the first control unit; and the first control unit is connected to a radio frequency circuit; the second antenna unit is connected with the second control unit; the second control unit is connected with the first control unit through the antenna matching unit; and the second control unit is grounded through the second antenna impedance unit.

The first control unit is configured to control conduction of the first antenna unit and the radio frequency circuit and conduction of the second antenna unit and the radio frequency circuit.

The second control unit is configured to control connection of the second antenna unit with the antenna matching unit and the second antenna impedance unit.

Further, the first antenna unit is provided with a plurality of first connection ends; the first antenna impedance unit includes: a plurality of antenna impedance networks; one of the first connection ends is connected with the first control unit through one of the antenna impedance networks; the second antenna unit is provided with a second connection end; and the second antenna unit is connected with the second control unit through the second connection end.

The first control unit is configured to control conduction of the first connection ends and the radio frequency circuit and conduction of the second antenna unit and the radio frequency circuit.

The second control unit is configured to control connection of the second connection end with the antenna matching unit and the second antenna impedance unit.

Further, the first control unit is configured to control conduction of connection ends and the radio frequency circuit and conduction of the second antenna unit and the radio frequency circuit in a manner of closing and/or opening a switch.

Further, the first control unit is configured to control conduction of the first connection ends and the radio frequency circuit and conduction of the second connection end and the radio frequency circuit according to a first control signal.

Further, the second control unit is configured to control connection of the second connection end with the antenna matching unit and the second antenna impedance unit in a manner of closing and/or opening a switch.

Further, the second control unit is configured to control connection of the second connection end with the antenna matching unit and the second antenna impedance unit in a manner of closing and/or opening a switch according to a second control signal.

Similarly, in order to solve the above technical problem, embodiments of the present invention also provide an antenna debugging method, in which the antenna is the above adjustable multi-band antenna provided with the first connection ends and the second connection end, and the method includes following steps:

selecting a corresponding first connection end to conduct with the radio frequency circuit through the first control unit;

disconnecting the second connection end from the antenna matching unit and the second antenna impedance unit through the second control unit;

generating a resonance point by adjusting antenna wiring of the first antenna unit, and then debugging a bandwidth of the first antenna unit by adjusting the antenna impedance networks not conducted with the radio frequency circuit; and

optimizing a frequency band of the first antenna unit by adjusting the antenna impedance networks conducted with the radio frequency circuit.

Similarly, in order to solve the above technical problem, embodiments of the present invention also provide an antenna debugging method, in which the antenna is the above adjustable multi-band antenna provided with the first connection ends and the second connection end, and the method includes following steps:

selecting a corresponding first connection end to conduct with the radio frequency circuit through the first control unit;

connecting the second connection end with the second antenna impedance unit through the second control unit;

generating a resonance point by adjusting antenna wiring of the first antenna unit, and then debugging a bandwidth of the first antenna unit by adjusting the antenna impedance networks not conducted with the radio frequency circuit;

optimizing a frequency band of the first antenna unit by adjusting the antenna impedance networks conducted with the radio frequency circuit; and

generating a resonance point by adjusting antenna wiring of the second antenna unit, and changing impedance of the first antenna unit through adjusting the second antenna impedance unit.

Similarly, in order to solve the above technical problem, embodiments of the present invention also provide an antenna debugging method, in which the antenna is the above adjustable multi-band antenna provided with the first connection ends and the second connection end, and the method includes following steps:

connecting the second connection end with the antenna matching unit through the second control unit;

making non-conduction between all the first connection ends and the radio frequency circuit through the first control unit, and conducting the second connection end and the radio frequency circuit; and

generating a resonance point by adjusting antenna wiring of the second antenna unit, and adjusting the antenna matching unit.

The present invention has the beneficial effects that:

Embodiments of the present invention provide an adjustable multi-band antenna and an antenna debugging method. The adjustable multi-band antenna of embodiments of the present invention includes: a first antenna unit, a second antenna unit, a first antenna impedance unit, a second antenna impedance unit, a first control unit, an antenna matching unit and a second control unit; the first antenna unit is connected with the first antenna impedance unit; the first antenna impedance unit is connected with the first control unit; and the first control unit is connected to a radio frequency circuit; the second antenna unit is connected with the second control unit; the second control unit is connected with the first control unit through the antenna matching unit; and the second control unit is grounded through the second antenna impedance unit. The first control unit is configured to control conduction of the first antenna unit and the radio frequency circuit and conduction of the second antenna unit and the radio frequency circuit; and the second control unit is configured to control connection of the second antenna unit with the antenna matching unit and the second antenna impedance unit. The adjustable multi-band antenna provided by the present invention can extend the bandwidth of the antenna by changing an antenna form and antenna impedance and increasing the frequency band of the antenna for users without changing the volume of the antenna, so as to realize a multi-band mobile phone antenna, and satisfy a development trend of miniaturization and ultrathin type of a mobile terminal.

### BRIEF DESCRIPTION OF DRAWINGS

FIG. 1 is a schematic structural diagram illustrating an adjustable multi-band antenna provided in embodiment I of the present invention;

FIG. 2 is a schematic structural diagram illustrating another adjustable multi-band antenna provided in embodiment I of the present invention;

FIG. 3 is a flow chart illustrating a first antenna debugging method provided in embodiment II of the present invention;

FIG. 4 is a flow chart illustrating a second antenna debugging method provided in embodiment II of the present invention;

FIG. 5 is a flow chart illustrating a third antenna debugging method provided in embodiment II of the present invention;

FIG. 6 is a schematic structural diagram illustrating an antenna system provided in embodiment III of the present invention;

FIG. 7 is a schematic diagram illustrating antenna wiring on a PCB provided in embodiment III of the present invention;

FIG. 8 is a schematic diagram illustrating a first antenna working band provided in embodiment IV of the present invention;

FIG. 9 is a schematic diagram illustrating a second antenna working band provided in embodiment IV of the present invention; and

FIG. 10 is a schematic diagram illustrating a third antenna working band provided in embodiment IV of the present invention.

### DETAILED DESCRIPTION

The present invention is further described in detail below in combination with drawings through specific embodiments.

### Embodiment I

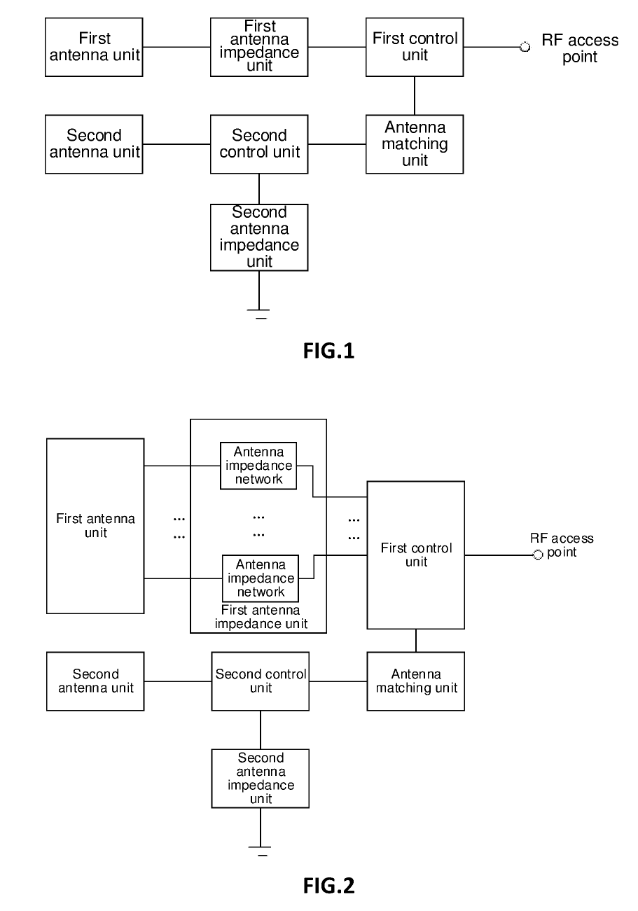

Considering a technical problem about how to extend the bandwidth of the antenna without increasing a volume of the antenna, the present embodiment provides an adjustable multi-band antenna. The antenna may be a monopole antenna, as shown in FIG. 1, and includes: a first antenna unit, a second antenna unit, a first antenna impedance unit, a second antenna impedance unit, a first control unit, an antenna matching unit and a second control unit.

The first antenna unit is connected with the first antenna impedance unit; the first antenna impedance unit is connected with the first control unit; and the first control unit is connected to a radio frequency circuit; the second antenna unit is connected with the second control unit; the second control unit is connected with the first control unit through the antenna matching unit; and the second control unit is grounded through the second antenna impedance unit.

The first control unit is configured to control conduction of the first antenna unit and the radio frequency circuit and conduction of the second antenna unit and the radio frequency circuit.

The second control unit is configured to control connection of the second antenna unit with the antenna matching unit and the second antenna impedance unit.

By applying the adjustable multi-band antenna provided in the present embodiment, a user can change an antenna form through the first control unit and the second control unit, so as to realize the change of the antenna form. Thus, different frequency bands are generated through resonance. Moreover, after the antenna form and an antenna radiation state are changed, the antenna impedance can be changed through the first antenna impedance unit, the second antenna impedance unit or the antenna matching unit to complete antenna debugging. The antenna in the present embodiment can extend the bandwidth of the antenna by changing the antenna form and antenna impedance and increasing the frequency bands of the antenna without changing the volume of the antenna, so as to realize a multi-band mobile phone antenna, and satisfy a development trend of miniaturization and ultrathin type of a mobile terminal.

The antenna form in the present embodiment mainly includes following three forms:

1. The first antenna unit is individually used as an antenna, i.e., the second antenna unit is not conducted with the radio frequency circuit; the first antenna unit disconnects the antenna matching unit and the second antenna impedance unit; the first antenna unit is conducted with the radio frequency circuit; and in this form, the first antenna unit can generate a corresponding resonance frequency band.

2. The second antenna unit is individually used as an antenna, i.e., the first antenna unit is not conducted with the radio frequency circuit; the second antenna unit is conducted with the radio frequency circuit through the antenna matching unit; the first antenna unit is not conducted with the radio frequency circuit; and in this case, a resonance frequency band can be generated.

3. The first antenna unit and the second antenna unit are jointly used as antennas, wherein the second antenna unit is grounded through the second antenna impedance unit. At this moment, the second antenna unit is a coupling unit of the first antenna unit, and belongs to part of the first antenna unit. The second antenna unit and the first antenna unit generate resonance frequency bands.

On the basis of changing the antenna form, the present embodiment can also change the radiation state of the first antenna unit, so as to further generate multiple resonant frequency bands. Preferably, in the present embodiment, the radiation state of the first antenna unit is changed by controlling conduction of a plurality of connection ends (such as elastic feet) of the first antenna unit and the radio frequency circuit. As shown in FIG. 2, specifically: based on the above antenna, the first antenna unit is provided with a plurality of first connection ends; the first antenna impedance unit includes: a plurality of antenna impedance networks; one of the first connection ends is connected with the first control unit through the antenna impedance networks; the second antenna unit is provided with a second connection end; and the second antenna unit is connected with the second control unit through the second connection end.

The first control unit is configured to control conduction of the first connection ends and the radio frequency circuit and conduction of the second antenna unit and the radio frequency circuit.

The second control unit is configured to control connection of the second connection end with the antenna matching unit and the second antenna impedance unit.

At this moment, after or when the antenna in the present embodiment changes the form, multiple different resonant frequency bands can be further generated by controlling conduction of connection ends of the first antenna and the radio frequency circuit. For example:

When the antenna is in a first form, a corresponding first connection end can be selected to conduct with the radio frequency circuit through the first control unit to change the radiation state of the first antenna unit, so as to generate different resonant frequency bands.

When the antenna is in a third form, a corresponding connection end can be selected to conduct with the radio frequency circuit to change the radiation state of the first antenna unit, so as to change the resonant frequency bands generated by the first antenna unit and the second antenna unit.

Through application of the antenna in the present embodiment, after the antenna form and the antenna radiation state are changed, the antenna impedance can also be changed through the antenna impedance networks, the second antenna impedance unit or the antenna matching unit to complete antenna debugging.

Preferably, the first control unit in the antenna of the present embodiment is configured to control conduction of connection ends and the radio frequency circuit and conduction of the second antenna unit and the radio frequency circuit in a manner of closing and/or opening a switch. At this moment, the first control unit may be a multi-way switch control unit; and each way is connected with one antenna impedance network and one first connection end in series.

Preferably, the first control unit is configured to control conduction of the first connection ends and the radio frequency circuit and conduction of the second connection end and the radio frequency circuit according to a first control signal.

In the present embodiment, a first control signal can be generated through a CPU and transmitted to the first control unit; and the first control signal can adopt GPIO, MIPI or other controllable signals.

In the present embodiment, similarly, the second control unit can also control connection of the second connection end with the antenna matching unit and the second antenna impedance unit in a manner of closing and/or opening a switch.

Specifically, the second control unit can also control connection of the second connection end with the antenna matching unit and the second antenna impedance unit in a manner of closing and/or opening a switch according to a second control signal.

The second control signal can be generated by CPU, and can adopt GPIO, MIPI or other controllable signals.

### Embodiment II

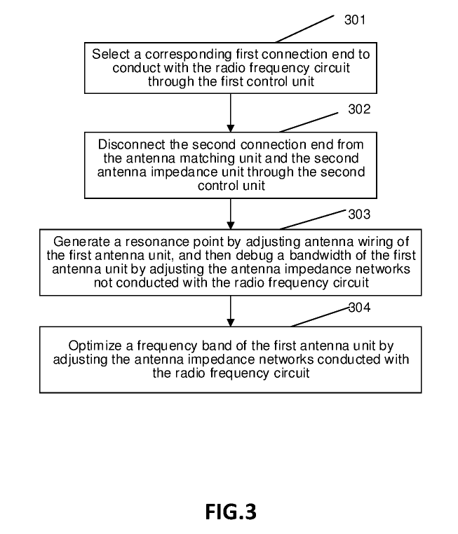

The present embodiment provides an antenna debugging method, the antenna is the above antenna shown in FIG. 2, and as shown in FIG. 3, the method includes following steps.

In step 301: a corresponding first connection end is selected to conduct with the radio frequency circuit through the first control unit;

in step 302: the second connection end is disconnected from the antenna matching unit and the second antenna impedance unit through the second control unit;

in step 303: a resonant point is generated by adjusting antenna wiring of the first antenna unit, and then a bandwidth of the first antenna unit is debugged by adjusting the antenna impedance networks not conducted with the radio frequency circuit; and

step 304: a frequency band of the first antenna unit is optimized by adjusting the antenna impedance networks conducted with the radio frequency circuit.

The antenna form debugged by using the above debugging method is: the first antenna unit is individually used as an antenna, and generates a resonant frequency band.

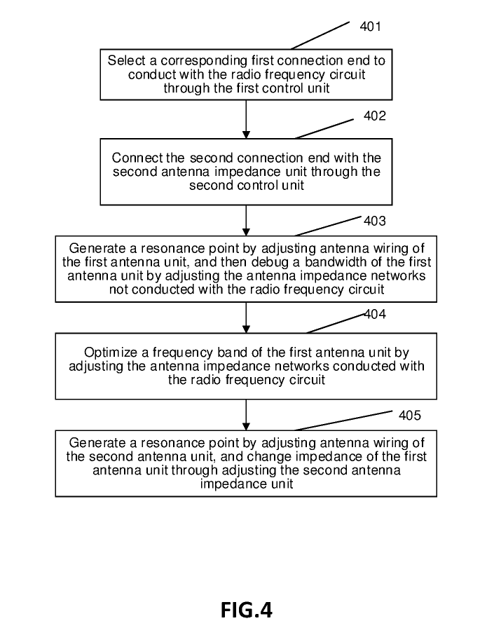

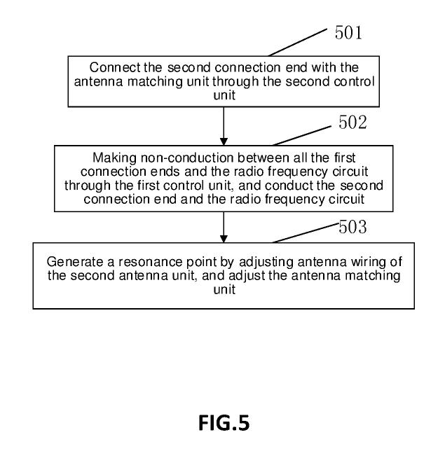

The present embodiment further provides an antenna debugging method, the antenna is the above antenna shown in FIG. 2, and as shown in FIG. 4, the method includes following steps.

In step 401: a corresponding first connection end is selected to conduct with the radio frequency circuit through the first control unit;

in step 402: the second connection end is connected with the second antenna impedance unit through the second control unit;

in step 403: a resonant point is generated by adjusting antenna wiring of the first antenna unit, and then a bandwidth of the first antenna unit is debugged by adjusting the antenna impedance networks not conducted with the radio frequency circuit;

in step 404: a frequency band of the first antenna unit is optimized by adjusting the antenna impedance networks conducted with the radio frequency circuit; and

in step 405: a resonant point is generated by adjusting antenna wiring of the second antenna unit, and impedance of the first antenna unit is changed through adjusting the second antenna impedance unit.

The antenna form debugged by using the above debugging method is: the first antenna unit and the second antenna unit are jointly used as antennas, and generate resonant frequency bands, wherein the second antenna unit is a coupling unit of the first antenna unit.

The present embodiment further provides an antenna debugging method, the antenna is the above antenna shown in FIG. 2, as shown in FIG. 5, and the method includes following steps.

In step 501: the second connection end is connected with the antenna matching unit through the second control unit;

in step 502: all the first connection ends are not conducted with the radio frequency circuit through the first control unit, and the second connection end and the radio frequency circuit are conducted; and

in step 503: a resonant point is generated by adjusting antenna wiring of the second antenna unit, and the antenna matching unit is adjusted.

The antenna form debugged by using the above debugging method is: the second antenna unit is individually used as an antenna, and generates a resonant frequency band.

### Embodiment III

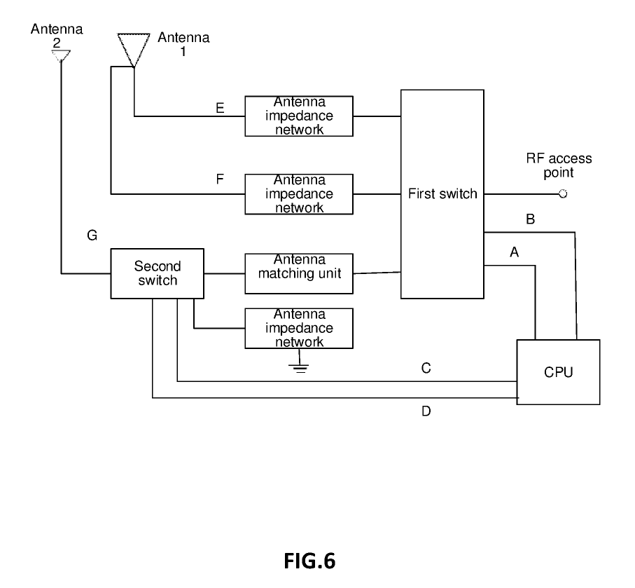

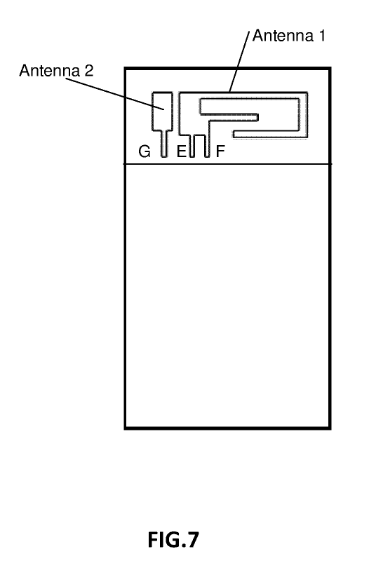

As shown in FIG. 6, the present embodiment provides an antenna system, including: an antenna 1, an antenna 2, an antenna impedance network, an antenna matching unit, an antenna impedance network, a first switch, a second switch and a CPU, wherein the antenna 1 has two contact elastic feet E and F. FIG. 7 shows wiring of the antenna 1 and the antenna 2 on a PCB. The elastic foot E of the antenna 1 is connected with the first switch through the antenna impedance network. The foot F of the antenna 1 is connected with the first switch through the antenna impedance network. The elastic foot G of the antenna 2 is connected with the second switch. The second switch is grounded through the antenna impedance network, and is connected with the first switch through the antenna matching unit.

The first control unit is configured to control conduction of the elastic feet E and F and the radio frequency circuit according to control signals A and B transmitted by the CPU, and control conduction of the elastic foot G and the radio frequency circuit.

The second control unit is configured to control connection or grounding of the elastic foot G and the antenna matching unit according to control signals C and D transmitted by the CPU.

In the present embodiment, E or F can be selected to conduct with the radio frequency circuit to change the radiation state of the antenna 1 through the first switch, and thus, different frequency bands are generated through resonance.

The first switch in the present embodiment can adopt a currently populay MIPI to control a radio frequency switch chip, wherein A and B are respectively clock and data control signals of the MIPI. In the present embodiment, the second switch can adopt a SP2T switch. The antenna in the present embodiment can control the first switch and the second switch through the CPU, so as to change a conduction state of the elastic feet and an impedance network of relevant elastic feet for realizing various radiation forms of the antenna under different conditions to realize multi-band debugging.

In the present embodiment, the antenna 2 is an independent radiating unit and has two forms: a first form is: the antenna 2 as an independent antenna has self antenna matching and mainly completes high-frequency resonance; and the other form is: the second switch control unit switches the elastic foot G to a circuit connected with ground. At this moment, the antenna 2 is used as a radiating body of the coupling unit of the antenna 1 and generates resonance.

The antenna shown in FIG. 6 can generate five antenna forms:

1. The antenna 2 is disconnected; E part of the antenna 1 is used as a monopole antenna of a signal feeder point; the monopole antenna generates resonance F1; specifically, the elastic foot G of the antenna 2 is disconnected through the second switch; the elastic foot E is selected to conduct with the radio frequency circuit through the first switch, which corresponds to the first antenna form in embodiment I.

2. The antenna 2 is conducted with the ground; E of the antenna 1 is used as a coupling radiating body of the monopole antenna and the antenna 2 of the signal feeder point to generate a resonant frequency band F2; specifically, the elastic foot G of the antenna 2 is switched to the ground through the second switch; the elastic foot E is selected to conduct with the radio frequency circuit through the first switch, which corresponds to the third antenna form in embodiment I.

3. The antenna 2 is disconnected; F part of the antenna 1 is used as a monopole antenna of a signal feeder point, and generates a resonant frequency band F3; specifically, the elastic foot G of the antenna 2 is disconnected through the second switch; the elastic foot F is selected to conduct with the radio frequency circuit through the first switch, which corresponds to the first antenna form in embodiment I.

4. The antenna 2 is conducted with the ground; F of the antenna 1 is used as a coupling radiating body of the monopole antenna and the antenna 2 of the signal feeder point to generate a resonant frequency band F4; specifically, the elastic foot G of the antenna 2 is switched to the ground through the second switch; the elastic foot F is selected to conduct with the radio frequency circuit through the first switch, which corresponds to the third antenna form in embodiment I.

5. The antenna 1 is disconnected; the antenna 2 is individually used as an antenna (generally generates a high-frequency part through resonance), and generates a resonant frequency band F5; specifically, the elastic feet E and F are disconnected through the first switch; the elastic foot G is conducted with the radio frequency circuit; the elastic foot G is switched to the antenna matching unit through the second switch, which corresponds to the second antenna form in embodiment I.

It can be seen that the antenna in the present embodiment can generate five resonant frequency bands, i.e., F1+F2+F3+F4+F5. In this way, the frequency bands are effectively increased and the bandwidth of the antenna is extended by changing the antenna form and the antenna impedance without additionally increasing the volume of the antenna, so as to realize a multi-band mobile phone antenna, and satisfy a development trend of miniaturization and ultrathin type of a mobile terminal.

### Embodiment IV

An debugging process of the antenna shown in FIG. 2 is introduced in the present embodiment:

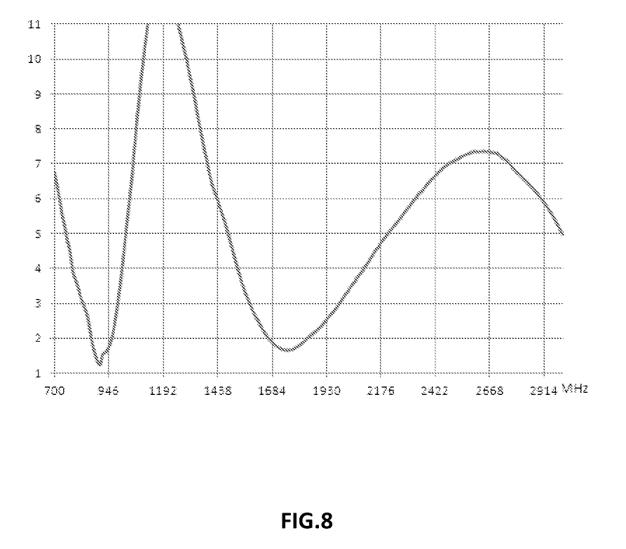

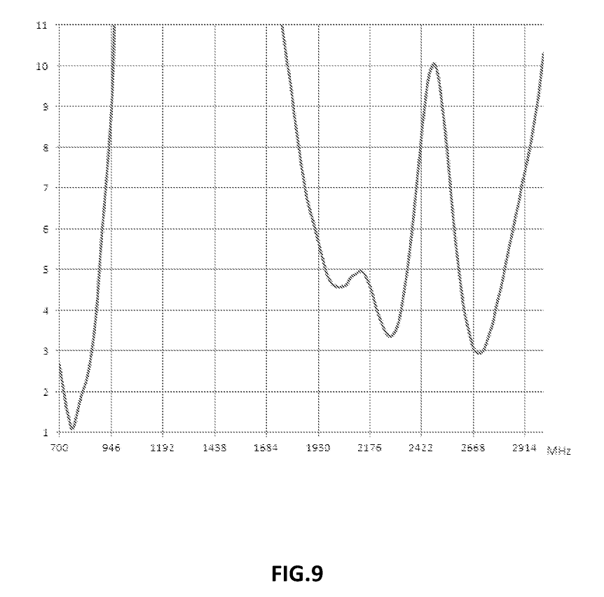

Debugging 1: As shown in FIG. 2, the first switch and the second switch are controlled through a master chip; elastic foot F of Antl is selected to conduct with an RF main circuit; elastic foot E is connected with the impedance network; the elastic foot of ANT2 is disconnected; at this moment, an antenna is in such a state that F point is used as a signal feeding point; elastic foot E is used as a double-feeding point monopole antenna connected with the impedance matching network; firstly, a resonant point is generated by adjusting antenna wiring; then the impedance network of the elastic foot E is adjusted so that the elastic foot E can be used as antenna matching for debugging the bandwidth of the antenna; and finally, relevant indexes are optimized by adjusting the impedance network of the elastic foot F. Debugging of the frequency band is completed finally. FIG. 8 shows VSWR tested in this mode for the final antenna. The antenna form is operated at GSM850 (824 MHz-894 MHz) GSM900 (880-960 MHz) GSM1800 (1710-1880 MHz).

Debugging 2: The state of the antenna ANTI keeps unchanged; the state of the antenna ANT2 is controlled through the master chip so that ANT2 is connected with the impedance network and then grounded; see debugging 1 for an debugging method; a difference is that the antenna ANT2 is used as an ANTI coupling unit and belongs to part of ANTI; by adjusting the wiring of ANT2, other frequency bands can be made through coupled resonance; finally, the impedance network of ANT2 connected with the ground can be debugged; by adjusting the network, impedance of the antenna ANTI is changed; and relevant frequency bands are optimized. The debugging step is only a general debugging process, and is not constant.

Debugging 3: The elastic foot E of ANTI is used as a signal feeding point, and the elastic foot F needs to be connected with the impedance network; the antenna ANT2 controls to disconnect the second switch through GPIO; see debugging 1 for the debugging method. It should be noted that the debugging needs to simultaneously consider the above two antenna states. FIG. 9 shows VSWR obtained by final antenna test. The antenna form is operated at B13 (746-787 MHz) B14 (758-798 MHz).

Debugging 4: By software control, the antenna form is a connection by using the elastic foot E of ANTI as the signal feeding point and using the elastic foot F as the impedance network, wherein ANT2 is connected with the impedance network and then grounded as a coupling parasitic unit; and see debugging 2 for the debugging step.

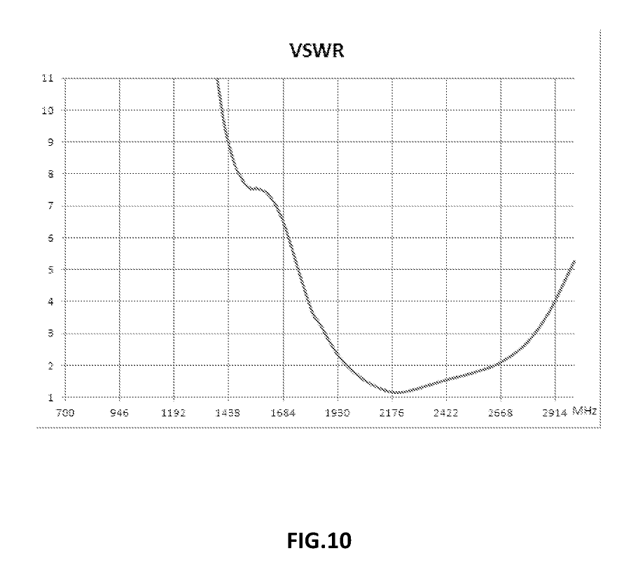

Debugging 5: By software control, two elastic feet of ANTI are disconnected from the radio frequency circuit; the elastic feet of the ANT2 are conducted with the radio frequency circuit; at this moment, ANT2 is individually used as a monopole antenna; by adjusting antenna wiring and antenna matching, the antenna is generally at resonant high frequency; FIG. 10 shows VSWR finally tested in this form. The antenna form is operated at B2 (1850-1990 Mhz) B34 (2010-2025 MHz) B40 (2300-2400MHz) B7 (2500-2620 MHz).

The above debugging is completed. GSM850/GSM900/GSM1800/B13/B14/B2/B34/B40/B7 frequency band is debugged in three states in the antenna form. Finally, according to an debugging result, radio frequency drive is reconfigured, so as to ensure that each frequency band is in a best state.

The above content is a further detailed description of the present invention in combination with specific embodiments, and the specific embodiments of the present invention shall not be deemed to be limited to these descriptions. Several simple deductions or replacements can also be made by those ordinary skilled in the art without departing from a conception of the present invention, and shall be regarded to belong to a protection scope of the present invention.

### INDUSTRIAL PRACTICALITY

As mentioned above, the adjustable multi-band antenna and the antenna debugging method provided in embodiments of the present invention have following beneficial effects: the adjustable multi-band antenna can extend the bandwidth of the antenna by changing the antenna form and the antenna impedance and increasing the frequency band of the antenna for users without changing the volume of the antenna, so as to realize a multi-band mobile phone antenna, and satisfy a development trend of miniaturization and ultrathin type of a mobile terminal.

1. An adjustable multi-band antenna, comprising: a first antenna unit, a second antenna unit, a first antenna impedance unit, a second antenna impedance unit, a first control unit, an antenna matching unit and a second control unit; wherein:
the first antenna unit is connected with the first antenna impedance unit; the first antenna impedance unit is connected with the first control unit; and the first control unit is connected to a radio frequency circuit; the second antenna unit is connected with the second control unit; the second control unit is connected with the first control unit through the antenna matching unit;
and the second control unit is grounded through the second antenna impedance unit;
the first control unit is configured to control conduction of the first antenna unit and the radio frequency circuit and conduction of the second antenna unit and the radio frequency circuit; and
the second control unit is configured to control connection of the second antenna unit with the antenna matching unit and the second antenna impedance unit.

2. The adjustable multi-band antenna of claim 1, wherein:
the first antenna unit comprises a plurality of first connection ends;
the first antenna impedance unit comprises=a plurality of antenna impedance networks; one of the first connection ends is connected with the first control unit through one of the antenna impedance networks;
the second antenna unit comprises a second connection end; and the second antenna unit is connected with the second control unit through the second connection end;
the first control unit is further configured to control conduction of the first connection ends and the radio frequency circuit and conduction of the second antenna unit and the radio frequency circuit; and
the second control unit is further configured to control connection of the second connection end with the antenna matching unit and the second antenna impedance unit.

3. The adjustable multi-band antenna of claim 2, wherein the first control unit is further configured to control conduction of connection ends and the radio frequency circuit and conduction of the second antenna unit and the radio frequency circuit to close and/or open a switch.

4. The adjustable multi-band antenna of claim 3, wherein the first control unit is further configured to control conduction of the first connection ends and the radio frequency circuit and conduction of the second connection end and the radio frequency circuit according to a first control signal.

5. The adjustable multi-band antenna of claim 2, wherein the second control unit is further configured to control connection of the second connection end with the antenna matching unit and the second antenna impedance unit opening a switch.

6. The adjustable multi-band antenna of claim 5, wherein the second control unit is further configured to control connection of the second connection end with the antenna matching unit and the second antenna impedance unit to close and/or open a switch according to a second control signal.

7. An antenna debugging method, wherein the antenna includes an adjustable multi-band antenna—comprising a first antenna unit, a second antenna unit, a first antenna impedance unit, a second antenna impedance unit, a first control unit, an antenna matching unit and a second control unit; wherein:
the first antenna unit is connected with the first antenna impedance unit; the first antenna impedance unit is connected with the first control unit; and the first control unit is connected to a radio frequency circuit; the second antenna unit is connected with the second control unit; the second control unit is connected with the first control unit through the antenna matching unit;
and the second control unit is grounded through the second antenna impedance unit;
the first control unit is configured to control conduction of the first antenna unit and the radio frequency circuit, and conduction of the second antenna unit and the radio frequency circuit; and
the second control unit is configured to control connection of the second antenna unit with the antenna matching unit and the second antenna impedance unit;
wherein the method comprises:
selecting a corresponding first connection end to conduct with the radio frequency circuit through the first control unit;
disconnecting a second connection end from the antenna matching unit and the second antenna impedance unit through the second control unit;
generating a resonance point by adjusting antenna wiring of the first antenna unit, and then debugging a bandwidth of the first antenna unit by adjusting antenna impedance networks not conducted with the radio frequency circuit; and
optimizing a frequency band of the first antenna unit by adjusting antenna impedance networks conducted with the radio frequency circuit.

8. An antenna debugging method, wherein the antenna includes an adjustable multi-band antenna- comprising a first antenna unit, a second antenna unit, a first antenna impedance unit, a second antenna impedance unit, a first control unit, an antenna matching unit and a second control unit; wherein:
the first antenna unit is connected with the first antenna impedance unit; the first antenna impedance unit is connected with the first control unit; and the first control unit is connected to a radio frequency circuit; the second antenna unit is connected with the second control unit; the second control unit is connected with the first control unit through the antenna matching unit; and the second control unit is grounded through the second antenna impedance unit;
the first control unit is configured to control conduction of the first antenna unit and the radio frequency circuit and conduction of the second antenna unit and the radio frequency circuit; and
the second control unit is configured to control connection of the second antenna unit with the antenna matching unit and the second antenna impedance unit;
wherein the method comprises:
selecting a corresponding first connection end to conduct with the radio frequency circuit through the first control unit;
connecting a second connection end with the second antenna impedance unit through the second control unit;
generating a resonance point by adjusting antenna wiring of the first antenna unit, and debugging a bandwidth of the first antenna unit by adjusting antenna impedance networks not conducted with the radio frequency circuit;
optimizing a frequency band of the first antenna unit by adjusting the antenna impedance networks conducted with the radio frequency circuit; and
generating a resonance point by adjusting antenna wiring of the second antenna unit, and changing impedance of the first antenna unit through adjusting the second antenna impedance unit.

9. An antenna debugging method, wherein the antenna includes an adjustable multi-band antenna comprising: a first antenna unit, a second antenna unit, a first antenna impedance unit, a second antenna impedance unit, a first control unit, an antenna matching unit and a second control unit; wherein:
the first antenna unit is connected with the first antenna impedance unit; the first antenna impedance unit is connected with the first control unit; and the first control unit is connected to a radio frequency circuit; the second antenna unit is connected with the second control unit; the second control unit is connected with the first control unit through the antenna matching unit; and the second control unit is grounded through the second antenna impedance unit;
the first control unit is configured to control conduction of the first antenna unit and the radio frequency circuit, and conduction of the second antenna unit and the radio frequency circuit; and
the second control unit is configured to control connection of the second antenna unit with the antenna matching unit and the second antenna impedance unit;
wherein the method comprises:
connecting a second connection end with the antenna matching unit through the second control unit;
making non-conduction between all first connection ends and the radio frequency circuit through the first control unit, and conducting the second connection end and the radio frequency circuit; and
generating a resonance point by adjusting antenna wiring of the second antenna unit, and adjusting the antenna matching unit.

10. The adjustable multi-band antenna of claim 3, wherein the second control unit is further configured to control connection of the second connection end with the antenna matching unit and the second antenna impedance unit to close and/or open a switch.

11. The adjustable multi-band antenna of claim 4, wherein the second control unit is further configured to control connection of the second connection end with the antenna matching unit and the second antenna impedance unit to close and/or open a switch.

12. The adjustable multi-band antenna of claim 10, wherein the second control unit is further configured to control connection of the second connection end with the antenna matching unit and the second antenna impedance unit to close and/or open a switch according to a second control signal.

13. The adjustable multi-band antenna of claim 11, wherein the second control unit is further configured to control connection of the second connection end with the antenna matching unit and the second antenna impedance unit to close and/or open a switch according to a second control signal.
